(19) United States
(12) Patent Application Publication
(10) Pub. No.: US 2007/0054508 A1
(43) Pub. Date: Mar. 8, 2007

(54) Rotatable connector

(76) Inventor: Tong-Hsin Cheng, Taipei (TW)

Correspondence Address: Tong-Hsin Cheng, P.O. Box No. 6-57, Junghe, Taipei, 235, TW

(21) Appl. No.: 11/218,518

(22) Filed: Sep. 6, 2005

(51) Int. Cl. H01R 39/00

(52) U.S. Cl. 439/13

(57) ABSTRACT

A rotatable connector according to the present invention includes a plug terminal to connect with a device and a socket terminal to connect with wires; wherein, the plug terminal and the socket terminal having an electrical connection through an axle within a sleeve that can rotate correspondingly with the socket terminal without the wires being twisted or tangled. Every circuit of the plug terminal is electrically connected to the circuit of the socket terminal through a connector consisted of two rolling balls to maintain good electrical connection and ensure the device to function normally when the wires and the device rotate correspondingly.

### BACKGROUND OF THE INVENTION

(a) Field of the Invention

The present invention relates to a connector and more particularly to a rotatable connector installed between wires and a device to provide the wires and the device with free rotation effect while avoiding the wires being twisted or tangled.

(b) Description of the Prior Art

Although a telephone can perform wireless signal transmission between a telephone transmitter and a telephone device, the communication quality thereof does not meet with expectations because of noises resulted from interruptions of wireless signals such as electric waves. Therefore, some telephones or facsimile machines still use wired signal transmission between the telephone transmitters and the telephone devices thereof to maintain communication quality, reduce volume of the device and manufacturing costs.

The biggest disadvantages of wired transmission are the transmission distance being limited by lengths of the wires and inconveniences caused by twisted and tangled wires. Thus, the conventional rotatable connectors applied between wires (such as telephone wires) and devices (such as telephone transmitters or telephone devices) have become available to the market. A conventional rotatable connector is consisted of a plug to be connected to the device and a socket connected to the wires. The aforesaid plug and the socket comprise a circuit connection through an axle that rotates correspondingly with the socket to enable the wires and the device to rotate freely without the wires being twisted or tangled.

However, the circuit connection between the plug and the socket of the conventional rotatable connector mostly adopts a contact method with single contact point. The circuit connection is affected by poor contact effects, and the aforesaid effect is more obvious when the plug and the socket rotate correspondingly, hence reducing the quality of the wired transmission and further affecting the operation of the device.

### SUMMARY OF THE INVENTION

In the view of the above, the primary object of the invention is to provide a rotatable connector that maintains good electric connection when the wires and the device rotate correspondingly and ensures normal operation of the device. A rotatable connector according to the present invention is enhanced by configuring two contact points with rolling balls in each circuit of a plug.

The rotatable connector is consisted of an axle and a socket that are installed in two sides of a sleeve respectively. Wherein, a plurality of terraced parts of the axle is configured toward the socket, and a spring is installed in the same direction as a diameter of the axle in each terraced part. Moreover, each spring with a rolling ball configured on each side is electrically connected to each terminal of the plug respectively, and an electricity conducting ring is installed around each terraced part. The electricity conducting rings do not contact mutually and only contact with the rolling balls in the terraced parts respectively. A plurality of electricity conducting springs that do not contact mutually but only contact with the corresponding electricity conducting rings is installed toward the axle on one side of the socket.

Resultingly, the rotatable connector connecting the socket and the plug through the axle is composed. When the wires and the device rotate correspondingly, the said rotatable connector maintains good electrical connection and ensures normal operation of the device with every circuit on one side of the plug electrically connected to every circuit of the socket through the rolling balls on both sides of the spring.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view of a plug in the first embodiment according to the invention.

FIG. 2 shows an elevational view of a socket in the first embodiment according to the invention.

FIG. 3 shows a schematic view illustrating an embodiment according to the invention.

FIG. 4 shows a structural sectional view according to the invention.

FIG. 5 shows an exploded elevational view according to the invention.

FIG. 6 shows an elevational view of an axle block according to the invention.

FIG. 7 shows an elevational view of a sleeve according to the invention.

FIG. 8 shows a structural sectional view of an axle according to the invention.

FIG. 9 shows an elevational view of a plug in the second embodiment according to the invention.

FIG. 10 shows an elevational view of a plug in the third embodiment according to the invention.

### DETAILED DESCRIPTION OF THE PREFERRED EMBODIMENTS

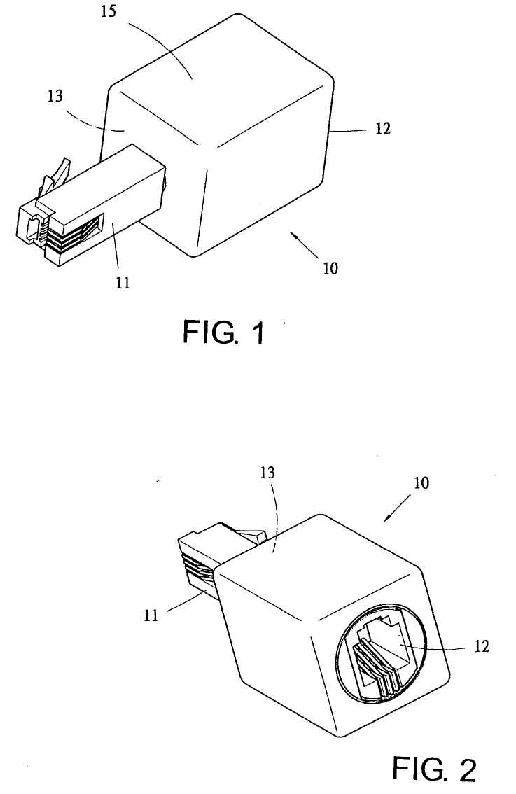

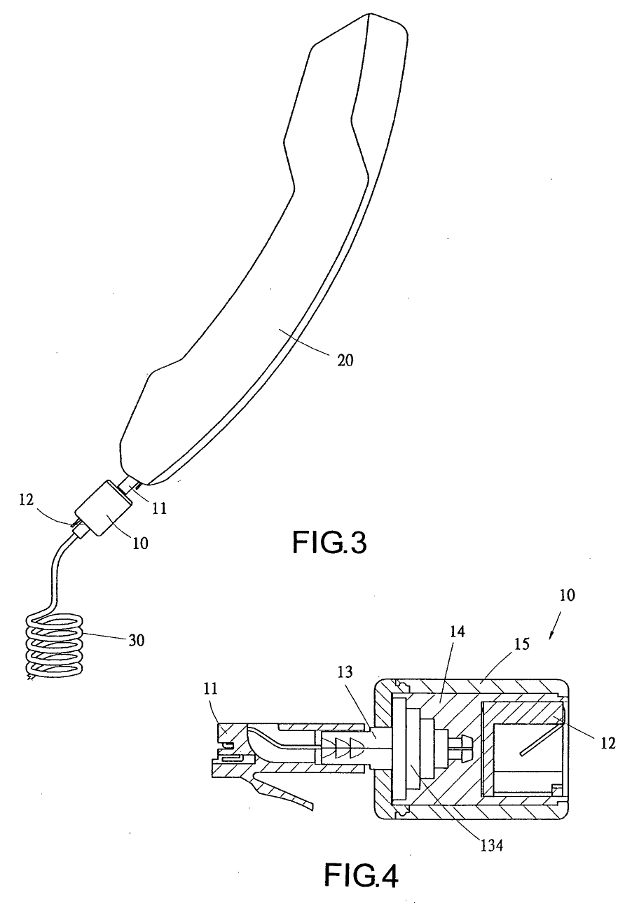

Referring to FIG. 1, FIG. 2, FIG. 3 and FIG. 4, the basic configuration of a rotatable connector according to the invention comprises a plug 11 connected to a device 20 and a socket 12 connected to wires 30. The plug 11 and the socket 12 form a circuit connection through an axle 13, which enables the wires 30 and a device 20 to rotate freely while avoiding the wires being twisted and tangled.

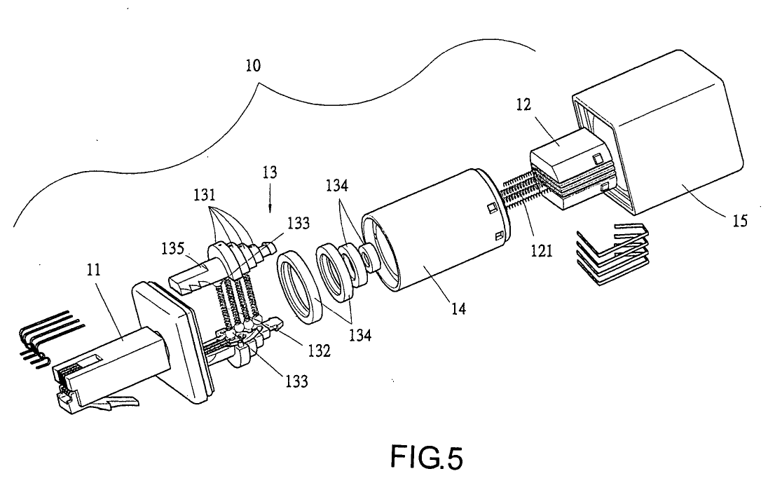

As shown in FIG. 4 and FIG. 5, a rotatable connector 10 is consisted of a sleeve 14 with an axle 13 and a socket 12 installed on each side respectively. The sleeve 14 is installed inside of an outer sleeve 15, and the axle 13 therein is configured with a plurality of terraced parts 131 toward the socket 12. Wherein, a spring 132 is radially configured in each terraced part 131 of the axle 13. Each spring 132 is devised with the rolling balls 133 on each side thereof, and each terraced part 131 is devised with an electricity conducting ring 134. Furthermore, the electricity conducting rings 134 do not contact mutually but only contact with the rolling balls 133 of the corresponding terraced parts 131 respectively.

A plurality of electricity conducting springs 121 that do not contact mutually but only contacting with the corresponding terminals and the electricity conducting rings 134 on one side of the axle 13 respectively is installed on one side of the socket 12.

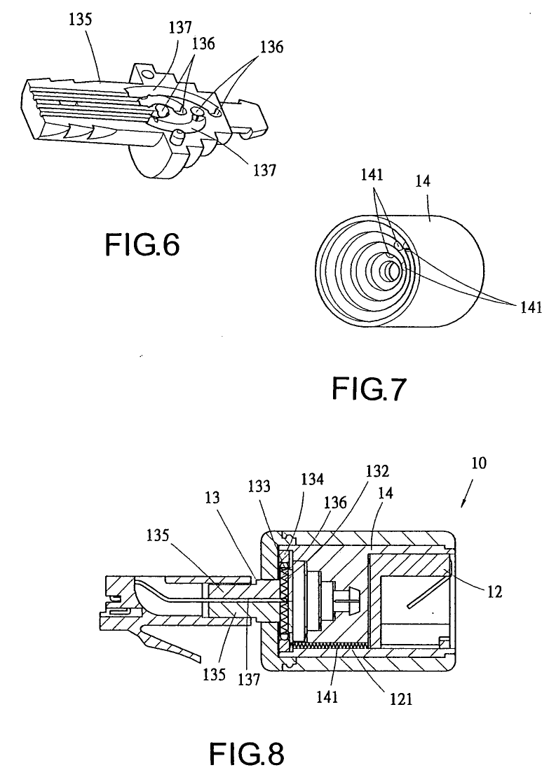

According to FIG. 5 and FIG. 6, an axle 13 is assembled by jointing two halves of an axle block 135. Each half of the axle block 135 thereof is configured with a plurality of cylindrical holes 136 to contain the springs 132 and rolling balls 133 thereof in the corresponding positions on each terraced part 131. Furthermore, tunnels 137 that enable the springs 137 to contact with the terminals are configured on the jointing surfaces of the axle blocks 135. As shown in FIG. 5 and FIG. 7, apertures 141 are configured on the corresponding positions of the sleeve 14 with each electricity conducting ring 134 therein to enable the electricity conducting springs 121 to pass through. Resultingly, the apertures 141 limit the positions of the electricity conducting springs 121, such that the electricity conducting springs 121 do not contact mutually but only contact with corresponding terminals and the electricity conducting rings 134 on one side of the axle 13, respectively.

Hence, referring to FIG. 8, when the wires and the device are rotated correspondingly, every circuit of one side of the plug 11 can electrically connect to the circuit on one side of the socket 12 through two connecting points consisted of rolling balls 133 to maintain good electrical connection and ensure normal operation of the device.

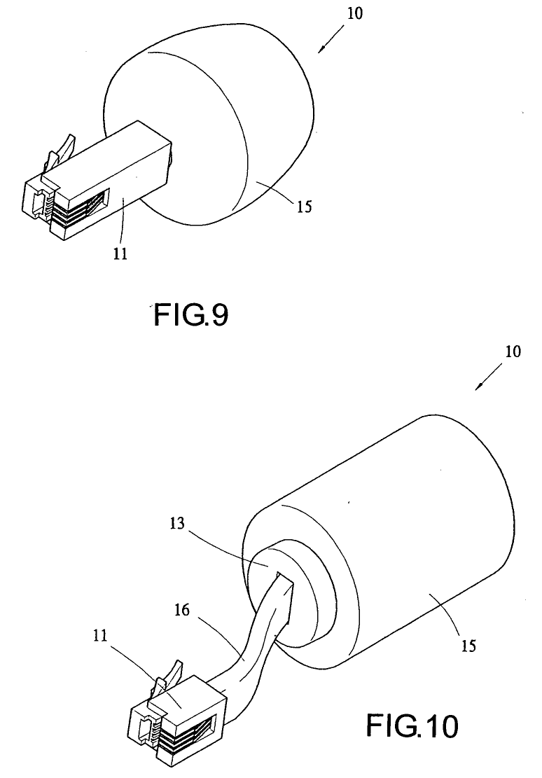

Moreover, an outer sleeve 15 of the rotatable connector 10 can be configured as a square shown in FIG. 1, as a shape of a wineglass shown in FIG. 9 or as a cylinder shown in FIG. 10 to provide a stylish appearance. A plug 11 with a flexible wire 16 in fixed length is connected with the axle 13 to enhance the rotatable connector 10.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A rotatable connector comprising a plug terminal to connect with a device, a socket terminal to connect with wires; wherein, the plug terminal and the socket terminal having an electrical connection through an axle within a sleeve that can rotate correspondingly with the socket terminal;
the axle including a plurality of first springs and a plurality of second springs; a plurality of terraced parts installed on the axle toward the socket terminal on one side of the sleeve and the socket terminal installed in the other side of the sleeve respectively, the first springs radially configured on every terraced parts of the axle with rolling balls electrically connected to terminals of the plug terminal on both sides respectively, a plurality of electrically conducting rings configured around the corresponding terraced parts respectively, such that the electricity conducting rings only contact with the rolling balls of the corresponding terraced part without mutual contacts, and a first springs being connected to the plug terminals and the second springs being connected to the socket terminals and the corresponding electricity conducting rings being disposed on one side of the axle respectively.

2. The rotatable connector in accordance with claim 1, wherein the axle comprising two jointed halves of an axle block, cylindrical holes to contain the first springs and the rolling balls configured in each axle block and in corresponding positions of the terraced parts, and tunnels configured on the jointing surfaces of two axle blocks to provide the connections of the first springs and the terminals.

3. The rotatable connector in accordance with claim 1, wherein an aperture is configured on the sleeve and at a position corresponding to each electricity conducting ring to enable an second spring to pass through.

4. The rotatable connector in accordance with claim 1, wherein the axle is assembled by jointing two halves of the axle blocks, the cylindrical holes to contain first springs and rolling balls are configured in each axle block and corresponding positions thereof on the terraced parts, and tunnels are configured on the jointing surfaces of two axle blocks to enable the connections of the first springs and the terminals, furthermore, an aperture is configured on the sleeve and at a position corresponding to each electricity conducting ring to enable an second spring to pass through.

5. The rotatable connector in accordance with claim 1, wherein a plug terminal and an axle are linked by a flexible wire with fixed length.

6. The rotatable connector in accordance with claim 1, wherein a sleeve is installed in an outer sleeve.
